(19) United States
(12) Patent Application Publication
(10) Pub. No.: US 2020/0342484 A1
(43) Pub. Date: Oct. 29, 2020

(54) Random System World Wide

(71) Applicant: Oswaldo Alfonso Araujo, Guayana City (VE)

(72) Inventor: Oswaldo Alfonso Araujo, Guayana City (VE)

(21) Appl. No.: 16/393,927

(22) Filed: Apr. 24, 2019

(51) Int. Cl. G06Q 30/02; G06Q 40/02

(52) U.S. Cl. CPC G06Q 30/0215; G06Q 40/02

(57) ABSTRACT

No doubt that using Credit Cards people obtain goods, but is time that they use them in order to obtain benefits, just at home comfort; waiting for being selected. Membership is going to be favored, Financial Institutions are going to be strengthened and economy in the country to apply the idea must improve, at least some 2.5%. Commercial locals would assure sell more and Financial Institutions would need more personnel to attend the demand on new ideas.

It is time to improve, to change in order to get better using Credit Cards. The way Financial Institutions sell the idea would make to approach how to install in the user mind such improvisations.

### CROSS-REFERENCES TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

It is an idea to adjust the definition of an Utility Non-Provisional which; by using Credit Cards normally goods are obtained (Electric Appliances or electronic devices, etc.) with financial support, but applying a software method could change with benefits membership; by decreasing consume debt or rather enjoy with a money order or a prepaid card buying partially those goods or totally, after being selected from the system application.

### (2) Description of the Related ART Including Information Disclosed Under 37 CFR 1.97 and 37 CFR 1.98

The idea of being selected in between 300 credit card holders has not been used before, so that the selected one can receive an important favored net percentage (300%) on first month, then 100% on the second month, 35.72% on third month and 18.04% on fourth month; if they want to enjoy the benefits described in proper documents. Otherwise, selected card holders receive 4 times the monthly discount amount on which the same card holders authorize Financial Institution to be registered into the defined application (one condition is: the card holders that are registered if He or She comes dead, then the Financial Institution must pay Credit Card debt).

### BRIEF SUMMARY OF THE INVENTION

The method is to make a monthly discount based in an authorization three hundred card holders send to a Financial Institution, so that the software selects in a Random way (from a table with 300 card holders that fulfill Institution requirements) each month, a number of favored card holders. On which they are not longer be discounted if they are favored and they are not participating any more (in that particular application).

### BRIEF DESCRIPTION OF THE SEVERAL VIEWS OF THE DRAWINGS

Not Applicable

### DETAILED DESCRIPTION OF THE INVENTION

On first month, the Random System selects fifteen card holders automatically; those card holders are receiving four times the monthly amount discount, so that they are able to decrease their consume debt or rather enjoy the benefits described in tables 1 and 5, showed in Member Manual (or see at the end).

On second month, the Random System selects twenty two card holders automatically; those card holders are receiving four times the monthly amount discount and it is repeated the same as in the first month after being selected.

On third month, the Random System selects thirty card holders automatically and will receive four times the monthly amount discount, but in this case the calculation Sheet will add 10.715% for each favored card holder if they decide to enjoy the benefits or rather decrease the consume debt, taking in consideration just four times the monthly amount discount.

On fourth month, the Random System selects forty card holders automatically and will receive four times the monthly amount discount, but in this case the calculation Sheet will add 18.036% for each favored card holder if they decide to enjoy the benefits or rather decrease consume debt, taking in consideration just four times the monthly amount discount.

Now, those 193 card holders that are not selected have to receive 77% (according to defined steps described along the application) on what they invested on those four months in order to decrease the consume, so they will pay only 23% to the Financial Institution: in a deposit or making a transfer (this has to be done at the end of fourth month).

Those 193 card holders that are not selected belong to a Completed Application; they have to wait for three more completed applications and because they honored their compromise with paying 23% to the Financial Institution, they qualify for being selected in between 772 card holders that were not selected at first, so the Random project will select 44 card holders on which will receive favored amounts according to their positions based on tables: Financial Institutions on Systems (22 favored card holders) and Financial Institution for Institution Duty (22 favored card holders). The average in four applications will define what it is the one to apply for the four completed applications: details appear on Member Manual, but the system will select 500 card holders more in order to give 14.5% back to the card holder consume based on the monthly discount, so 77% plus this 14.5% will be back to the card holder after a running month (fifth one). Besides, 228 card holders left receive 13.19% plus 77% will be back to the Card Holder Consume debt, after a month (fifth one).

It is important to mention that the favored card holders have only 48 hours to send a communication to Financial Institution in order to inform that they want to enjoy the benefits, otherwise the Financial Institution will decrease the Card Holder consume debt with the favored amount. On those 500 and 228 card holders, Institution just will put back the amount calculated on the Calculation Sheet, to the card holder consume.

TABLE 1
After selected in 1 Application and the Member has 50% or less in limit
can apply for this offer

| Selection | Selected | Paying in cash | Credit Approval | Any Order on $ |
|---|---|---|---|---|
| 70 | 280 | 140 | 140 | 560 |
| 80 | 320 | 160 | 160 | 640 |
| 90 | 360 | 180 | 180 | 720 |
| 100 | 400 | 200 | 200 | 800 |

TABLE 5
After selected in 1 Application and the Member has 50% or less in limit
can apply for this offer

| Selection | Selected | Paying in cash | Credit Approval | Any Order on $ |
|---|---|---|---|---|
| 110 | 440 | 220 | 220 | 880 |
| 120 | 480 | 240 | 240 | 960 |
| 130 | 520 | 260 | 260 | 1040 |
| 140 | 560 | 280 | 280 | 1120 |

Tables of FINANCIAL INSTITUTION ON SYSTEM

Selected 4 Applc. Member has 60% or less in limit can apply for this
offer (22 first position Members)

| Selection | Selected | Paying in cash | Credit Approval | Any Order on $ |
|---|---|---|---|---|
| 70 | 102 | 100 | 110 | 312 |
| 80 | 130 | 120 | 130 | 380 |
| 90 | 150 | 140 | 150 | 440 |
| 100 | 170 | 160 | 170 | 500 |
| 110 | 190 | 180 | 190 | 560 |
| 120 | 210 | 200 | 210 | 620 |
| 130 | 230 | 223 | 230 | 683 |
| 140 | 250 | 246 | 250 | 746 |

Tables of FINANCIAL INSTITUTION FOR INSTITUTION DUTY

Selected 4 Applc. Member has 60% or less in limit can apply for this
offer (22 second position Members)

| Selection | Selected | Paying in cash | Credit Approval | Any Order on $ |
|---|---|---|---|---|
| 70 | 90 | 90 | 103 | 283 |
| 80 | 100 | 110 | 126 | 336 |
| 90 | 110 | 130 | 149 | 389 |
| 100 | 120 | 183 | 173 | 477 |

Selected 4 Applc. Member has 60% or less in limit can apply for this
offer (22 second position Members)

| Selection | Selected | Paying in cash | Credit Approval | Any Order on $ |
|---|---|---|---|---|
| 110 | 130 | 203 | 196 | 529 |
| 120 | 140 | 223 | 220 | 583 |
| 130 | 150 | 243 | 243 | 636 |
| 140 | 160 | 263 | 266 | 689 |

1. Credit Card Holder normally uses them in order to obtain goods, but never to use Credit Cards to get benefits and If there is a special condition on which a Holder comes dead (for natural reasons) Financial Institution pay Credit Card debt (while is registered in that program)
Three hundred Card Holders who belong to a Financial Institution are going to be selected on first, second, third and fourth month, but 193 are not selected at first, they have to pay on the fourth month 23%. The Random System is designed so that this completed application needs three more completed: compounding 4 applications make 772 card holders that are not selected at first.
After running one more month, those 772 card holders qualify to be selected in a Random way at last. Forty four card holders are selected with the conditions established and the rest 500 and 228 are going to be selected at the same time, they are going to receive percentage defined by the System and verified by the Financial Institution. So, 728 card holders are going to receive 77% plus 14.5% equal to 91.5% and 77% plus13.19% equal to 90.19% (respectively and directly to the Credit Card Consume Debt).
